(19) United States
(12) Patent Application Publication
(10) Pub. No.: US 2002/0045029 A1
(43) Pub. Date: Apr. 18, 2002

(54) Mat used in cars

(76) Inventor: Ming-Shun Yung, Taipei (TW)

Correspondence Address: ERIK M. ARNHEM, 4250 Wilshire Blvd., Los Angeles, CA, 90010, US

(21) Appl. No.: 09/903,202

(22) Filed: Jul. 11, 2001

Related U.S. Application Data
(63) Continuation-in-part of application No. 09/354,067, filed on Jul. 15, 1999, now Pat. No. 6,261,667.

(51) Int. Cl. B32B 3/30

(52) U.S. Cl. 428/172

(57) ABSTRACT

An improved mat used in cars includes an upper polyester fabric, a middle plastic plate or layer, and an under net lining. All three parts are stuck together, and bound to form a plate-shaped object. The plate-shaped object of the mat is formed by multiple sy,metrical umbos. There are multiple symmetrical bevel grooves formed between these umbos naturally, and the grooves are downward. The sideways grooves therefore can collect the muck on the shoes, and is convenient for people to take the mat out to wash without dirty the carpet. Additionally, multiple foam particles are created on the under net lining of the mat. The mat will not move on the carpet by these foam particles.

### BACKGROUND OF THE INVENTION

The invention is a kind of mat used in cars. People put it on the car carpet, because of its special structure when stepping on it the mat will not move, and at the same time avoids the mud and gravel on the shoes dirty the carpet. Furthermore, there are, multiple symmetrical bevel grooves formed in the plate-shaped mat to collect the water tracked on the mat, and it is convenient for people to take the mat out to wash.

Usually, people pave classy carpet in a car for beautifying the interior of the car. However, in order to keep the carpet from defiling by people's tread, many people puts a set of mats (four pieces, two for the front seats and two for the rear seats) on the carpet. Conventional car mats are putted on the carpet without any design to fix the mat with the carpet, when people step on the mat, the mat will be moved. It may influence the safety of driving and defeats the purpose of the mat of its intended covering area. It is therefore need to be improved.

Additionally, the design of the conventional car mat is flat, therefore, after using for a while, the sludge, gravel, and rainwater on the shoes will not only dirty the carpet, but also deface the inside of the car. It is the defect of the conventional car mat.

Due to the defect of the conventional car mats on practice, the inventor designs an improved structure of car mat. The structure of the car mat is not only to improve the function of avoiding slide, but also to collect the sludge and gravel on the shoes, and will not dirty the carpet. Therewith, these multiple symmetrical bevel grooves formed in the plate-shaped car mat can collect the water tracked on the mat, and it is convenient for peoplelto take the mat out to wash.

### SUMMARY OF THE INVENTION

An improved mat used in cars includes an upper polyester fabric, a middle -plastic plate or layer and an under net lining. All three parts are stuck together, and bound to form a plate-shaped object. The plate-shaped object of the mat is formed by multiple syrnmetrical umbos. There are multiple symmetrical bevel grooves formed between these umbos naturally, and the grooves are downward. The sideways grooves therefore can collect the muck on the shoes, and is convenient for people to take the mat out to wash without dirty the carpet. Additionally, multiple foam particles are created on the under net lining of the mat. The mat will not move on the carpetr by these foam particles.

### BRIEF DESCRIPTION OF THE DRAWINGS

FIG. 1 is a perspactive view of the improved mat used in cars of this invention.

FIG. 2 is a structure view of the unformed mat of this invention.

FIG. 3 is an Y-Y section view of the improved mat used in cars of this invention.

FIG. 4 is an X-X section view of the improved mat used in cars of this invention.

### DETAILED DESCRIPTION

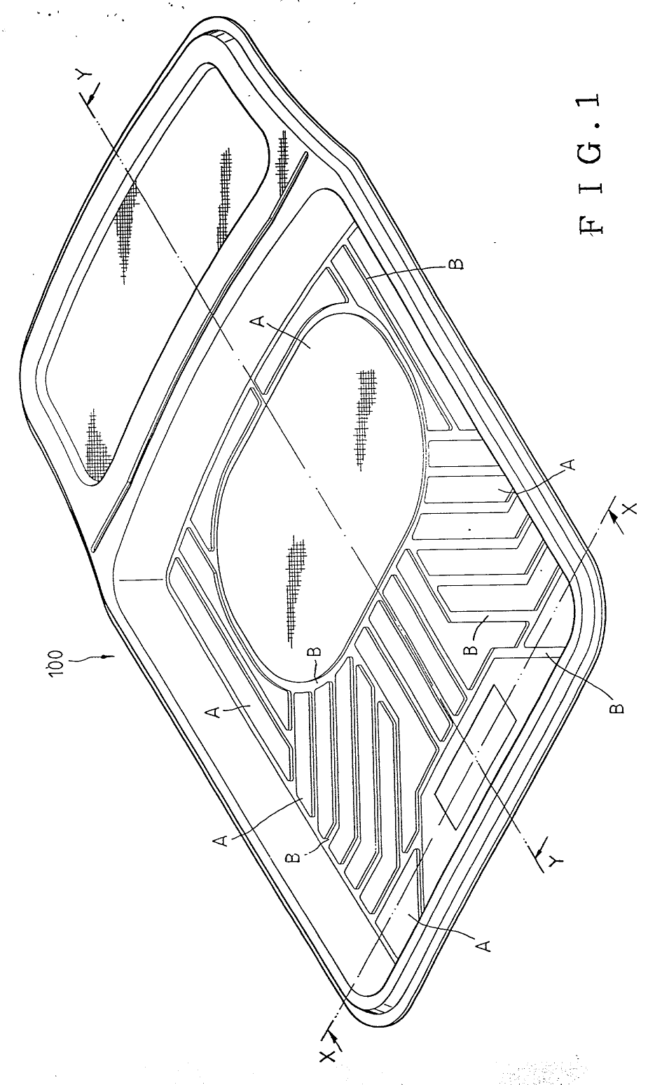

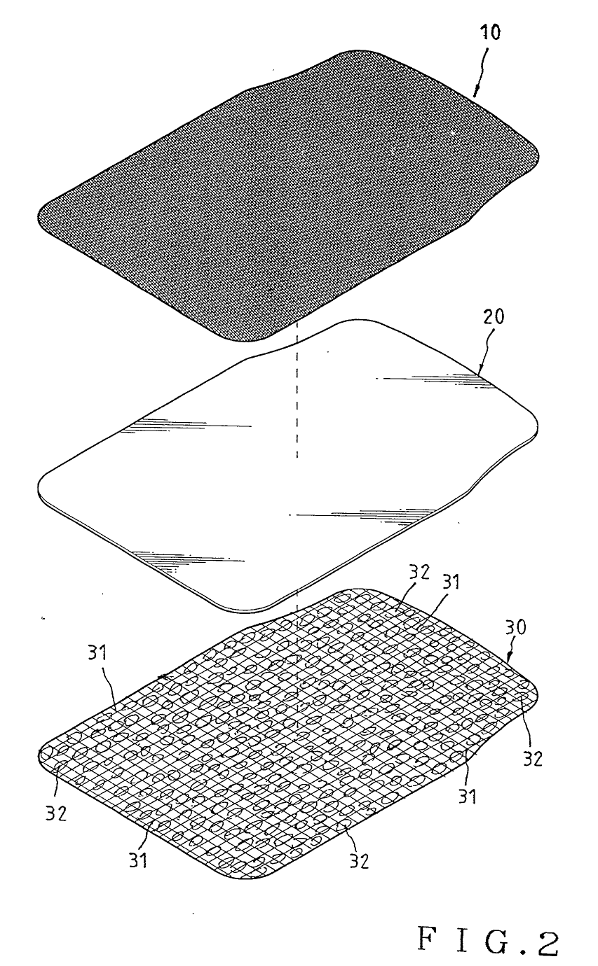

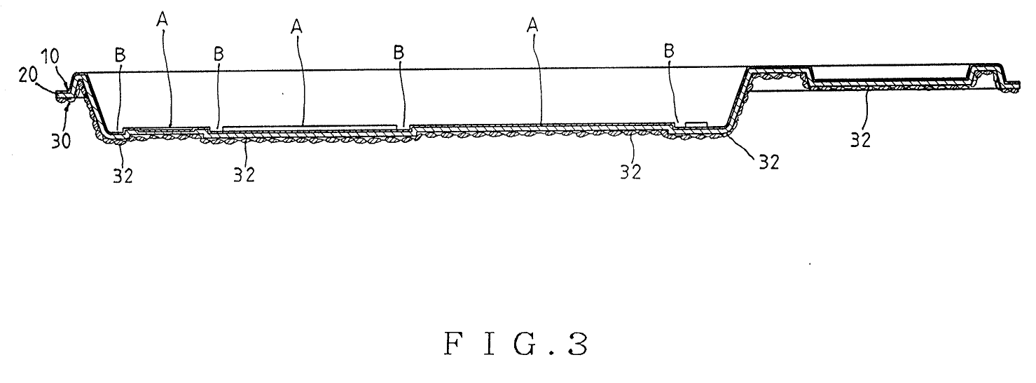

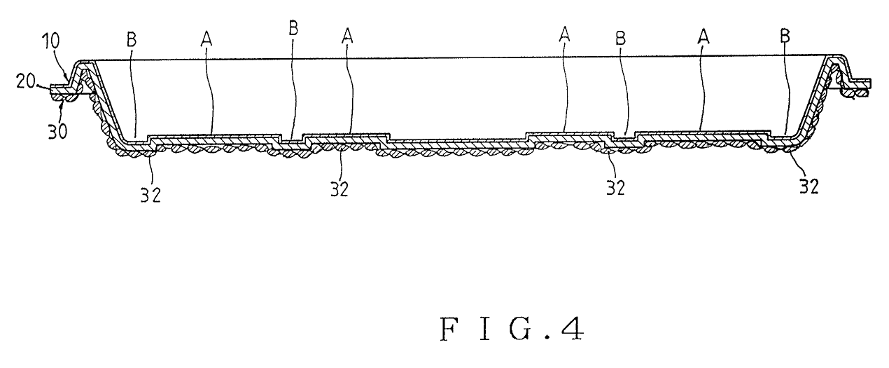

As FIGS. 1, 2, 3, and 4 shown that an improved mat used in cars (100) is consisting of an upper polyester fabric (l0),a middle Plastic plate or layer (20), and an under net lining (30).

The material of the above mentioned middle plastic plate or layer (20) as a flexible, light weight, and waterproof Polyethylene (PE) or Polyethylene—Vinyl Acetate (EVA) foam. The above mentioned net lining (30) is composed of multiple yarns or threads (31) woven or knotted in a combination of both horizontal and longitudinal ways to form a net fabric. This net fabric was dipped and coated with plastic (PVC etc.) resins, which are for10 mulated with foam)ng agent. This coated fabric after being treated by heatfoaming process, along the threads or yarns (31) continuous sponge foam will be formed on the thread or yarn surface in a suitable thickness and on each knot place foam particle (32) will be created also. The improved mat used in cars (100) of this invention is formed by sticking the net lining (30) with multiple foam particle (32), aforesaid middle, plastic plate or layer (20), and the upper polyester fabric (10) together, and binning the three parts to form a whole mat as shown in FIG. 1.

As figures shown that the mat (100) of this invention is a plate-shaped object, and there is a shallow plate-shaped object at the front flange of the mat. The plate-shaped object and the shallow plate-shaped object are for people to step on. The mat can be placed freely depends on the locations of the front seat and rear seat.

The plate-shaped object of the above mentioned mat (100) is formed by multiple symmetrical umbos(A) which can be designed as rectangle quarry, or figure etc. There are multiple symmetrical bevel grooves (B) formed between these umbos (A) naturally, and the grooves (B) are downward. When the sludge, gravel, and rainwater on the shoes are tracked on the mat (100), people can scraped on the umbos (A), then sideways grooves (B) will collect the muck on the shoes together, and it is convenient for people to take the mat out to wash. At the same time, the muck will not dirty the carpet because of the design of plate-shaped mat. It will keep the carpet clean, and will not deface the inside of the car.

There are multiple foam particles (32) are created on the under net lining (30) of the mat (100) of this invention. The multiple foam particles (32) of the mat (100) will cling to the fibers of the carpet under the mat (100), and create the drag between the mat and carpet. By this way, the mat will not move on the carpet.

From the above description, the structure of the mat (100) is simple, but the present invention is novel in design by using the three different inds of material,a polyester fabric (10), a plastic plate or layer (20), and a net lining (30). Then bound these three parts to form a whole plate-shaped mat, and the mat (100) will not move on the carpet. It is therefore better and largely improved than the conventional mat.

In the claims:

6. A one piece floor mat for use in automotive vehicles comprising:
a three layer laminated mat body that includes a middle layer, upper layer, and lower layer bonded together at the interfaces between said layers;
said middle layer comprising a flexible impermeable plastic sheet that is impervious to liquid flow therethrough;
said upper layer comprising a woven plastic sheet bonded to the upper surface of said middle layer;
said lower layer comprising a woven net fabric coated with a plastic foam, said lower layer being bonded to the lower surface of said middle layer;
said laminated mat body being embossed to form multiple water collection grooves on the mat body upper surface.

7. The floor mat of claim 6, wherein said laminated mat body has a peripheral upstanding rim for containing of water sludge and debris collected on the mat body, said rim having an inverted V cross-section.
